(19) United States
(12) Patent Application Publication
(10) Pub. No.: US 2011/0260510 A1
(43) Pub. Date: Oct. 27, 2011

(54) BICYCLE SEAT WITH SHOCK ABSORBING DEVICE

(75) Inventor: JUNG YU HSU, TAINAN CITY (TW)

(73) Assignee: KIND SHOCK HI-TECH CO., LTD., TAINAN CITY (TW)

(21) Appl. No.: 12/970,009

(22) Filed: Dec. 16, 2010

(30) Foreign Application Priority Data
Apr. 27, 2010 (TW) 099207634

(51) Int. Cl. B62J 1/02

(52) U.S. Cl. 297/201

(57) ABSTRACT

A bicycle seat includes two parts and a spring member is connected between the two respective rear ends of the first and second parts. A first fixing member is fixed to an underside of the spring member. A second fixing member is connected across the two respective front ends of the first and second parts respectively. A frame includes a closed end, a first distal end and a second distal end, the closed end is inserted into the reception recess of the second fixing member. The two distal ends of the frame are connected to the two ends of the first fixing member. The two parts are individually deformed when the cyclist changes his/her poses.

### FIELD OF THE INVENTION

The present invention relates to a bicycle seat, and more particularly, to a bicycle seat including two individual parts and a spring board connected between the two individual parts which are individually deformed for adaptation of weight center change of the cyclist.

### BACKGROUND OF THE INVENTION

A conventional bicycle seat is directly in contact with the body of the cyclist and when the cyclist change his/her weight center, the bicycle seat directly corresponds to the change. The conventional bicycle seat is a one-piece part which has a shock absorbing device connected to an underside thereof so that when the bicycle turns, goes upward, goes downward, or rides over a bump, the weight center of the cyclist changes because the cyclist's hip changes its poses. The conventional bicycle seat cannot be properly deformed along with the change of the weight center of the cyclist so that the cyclist does not feel comfortable.

A Taiwan Published Patent Application No. M373860 discloses a shock absorbing seat and includes a main part and a locking portion which is securely connected with the board portion of a spring board. The spring board includes two wings and each wing has a tubular portion connected thereto. A U-shaped frame includes two arms extending backward from two ends thereof and the two arms are connected to the two wings and the closed end of the U-shaped frame is inserted in a fixing member located at the front end of the main part of the bicycle seat. The u-shaped frame is easily to be installed to the seat or removed from the seat.

However, the main part is a one-piece part and cannot be deformed along with the poses change of the cyclist and the spring board is fixed to the one-piece part so that it cannot provide satisfied shock absorbing functions.

The present invention intends to provide a bicycle seat which includes two individual parts which can be deformed according change of weight center of the cyclist.

### SUMMARY OF THE INVENTION

The present invention relates to a bicycle seat and comprises a first part and a second part, and each of the two parts has a narrow front end and a wide rear end. The first and second parts are located side by side. A spring member has two ends fixed to the two respective rear ends of the first and second parts respectively. A first fixing member is fixed to an underside of the spring member and a second fixing member is connected across the two respective front ends of the first and second parts respectively.

The first and second parts are two individual parts.

The spring member includes at least one first threaded hole defined in a mediate portion thereof.

The first fixing member includes a second threaded hole which is located corresponding to the at least one first threaded hole. Two passages are defined in two ends of the first fixing member. Two third threaded holes are respectively defined through a wall of the two ends of the first fixing member and communicate with the two passages respectively.

A first bolt is connected to the second threaded hole of the first fixing member.

A second bolt is connected to the third threaded hole of the first fixing member.

The spring member is a spring board and includes two slots defined therein.

The second fixing member has a reception recess. A frame includes a closed end, a first distal end and a second distal end, wherein the closed end is inserted into the reception recess of the second fixing member.

The first and second parts can alternatively be connected at respective front ends thereof so as to from a closed area. A gap is defined longitudinally from the closed area to the rear ends of the first and second parts.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bicycle seat of the present invention;

FIG. 2 is a perspective view to show the bicycle seat of the present invention;

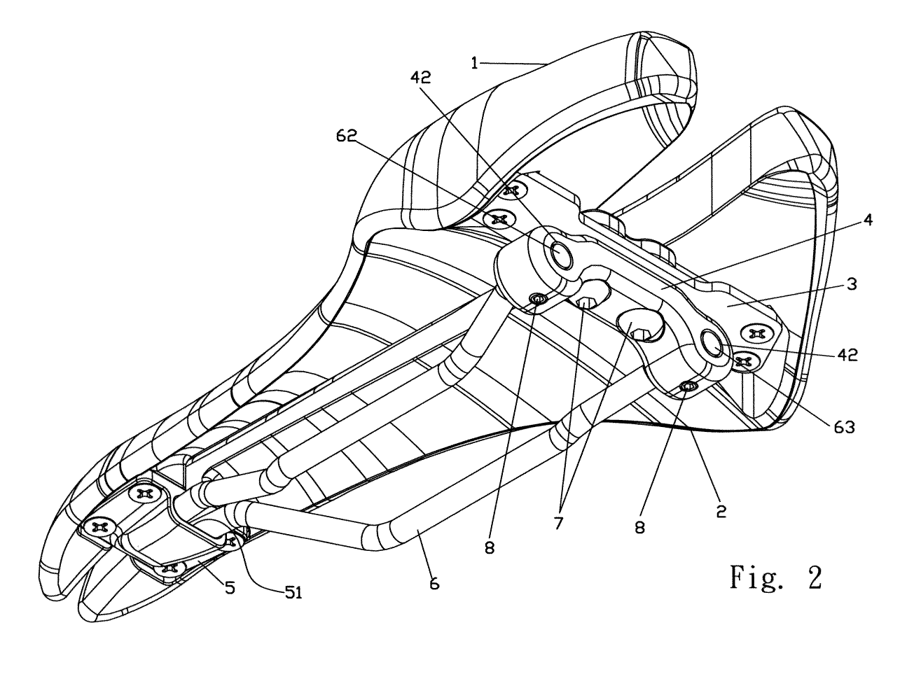

FIG. 3 is an end cross sectional view of the bicycle seat of the present invention;

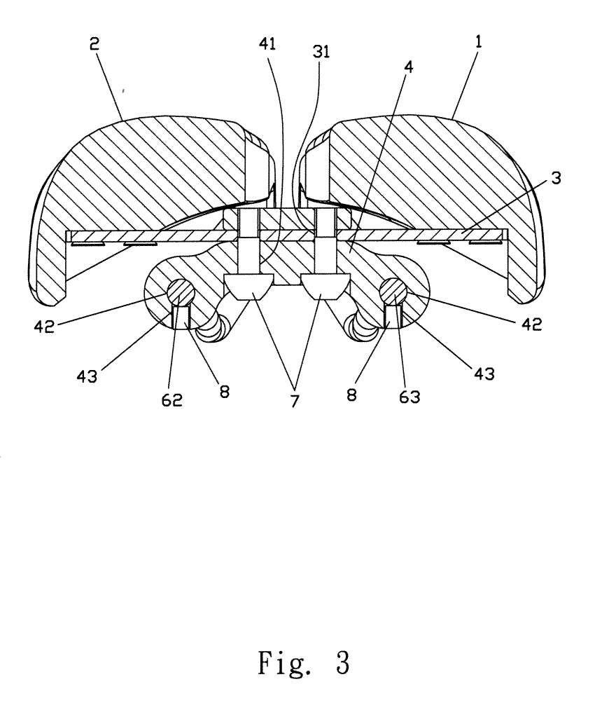

FIG. 4 is an end cross sectional view of the bicycle seat of the present invention, wherein the first part is applied by a force;

FIG. 5 is an end cross sectional view of the bicycle seat of the present invention, wherein the second part is applied by a force;

FIG. 6 shows another embodiment of the spring member of the bicycle seat of the present invention, and

FIG. 7 shows another embodiment of the bicycle seat of the present invention.

### DETAILED DESCRIPTION OF THE PREFERRED EMBODIMENT

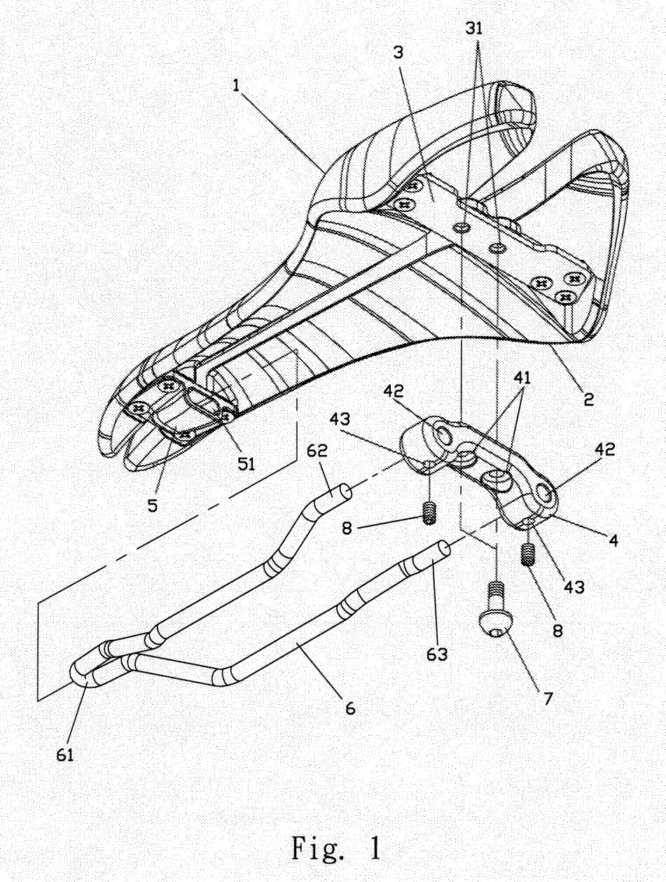

Referring to FIG. 1, the bicycle seat of the present invention comprises a first part 1 which has a narrow front end and a wide rear end. A second part 2 has a narrow front end and a wide rear end. The first and second parts 1, 2 are located side by side. The first and second parts 1, 2 are two individual parts.

A spring member 3 has two ends fixed to the two respective rear ends of the first and second parts 1, 2 respectively. The spring member 3 includes at least one first threaded hole 31 defined in a mediate portion thereof. The spring member 3 is a spring board and includes two slots 32 defined therein.

A first fixing member 4 is fixed to an underside of the spring member 3 and includes a second threaded hole 41 which is located corresponding to the at least one first threaded hole 31. Two passages 42 are defined in two ends of the first fixing member 4. Two third threaded holes 43 are respectively defined through a wall of the two ends of the first fixing member 4 and communicate with the two passages 42 respectively.

A second fixing member 5 is connected across the two respective front ends of the first and second parts 1, 2 respectively. The second fixing member 5 has a reception recess 51.

A frame 6 includes a closed end 61, a first distal end 62 and a second distal end 63. The closed end 61 is inserted into the reception recess 51 of the second fixing member 5.

A first bolt 7 is connected to the second threaded hole 41 of the first fixing member 4 and the first threaded hole 31 of the spring member 3.

A second bolt 8 is connected to the third threaded hole 43 of the first fixing member 4 and contacts against the first/second distal end 62/63 in the passages 42.

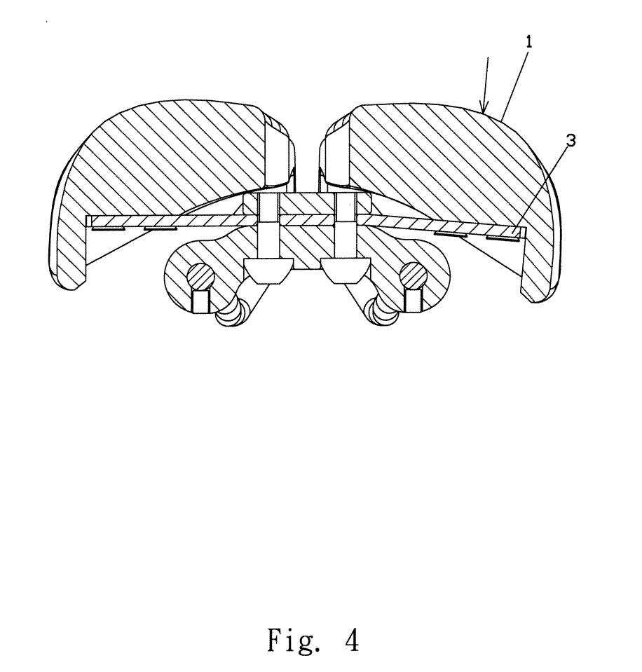

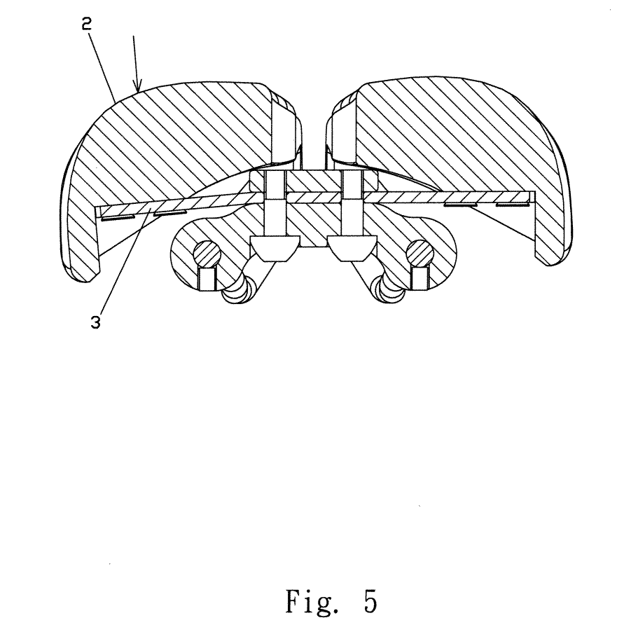

As shown in FIGS. 4 and 5, when the first and second parts 1, 2 are applied forces respectively, the cyclist change the poses by changing the positions of the weight center and the hip portion of the cyclist moves left and right when necessary. The spring member 3 is deformed to absorb the forces (shocks) so that the first and second parts 1, 2 can be individually lowered when the cyclist changes the weight center to the part 1/2. The first and second parts 1, 2 return to their original positions when the weight center moves away.

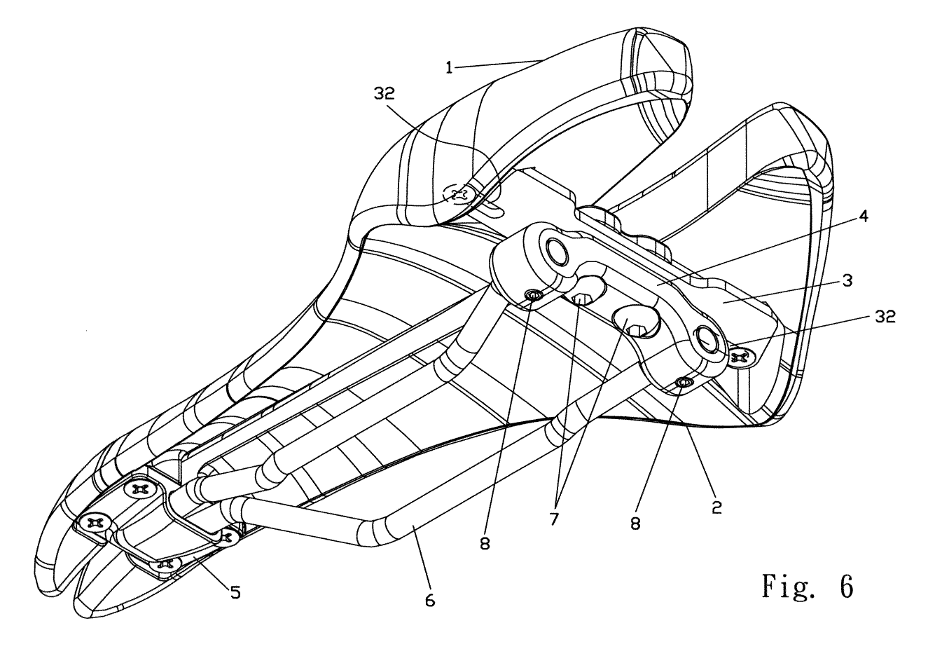

As shown in FIG. 6, the spring member 3 includes two slots 32 defined longitudinally in two ends thereof so that the bolts can fix the two ends of the spring member 3 at different positions and this adjusts the length of the arm of force of the spring member 3 for the first and second parts 1, 2. By the position that the bolt is located in the slot 32 to fix the spring member 3 to the first/second part 1/2, the first/second part 1/2 can be adjusted to be soft or stiff when being deformed.

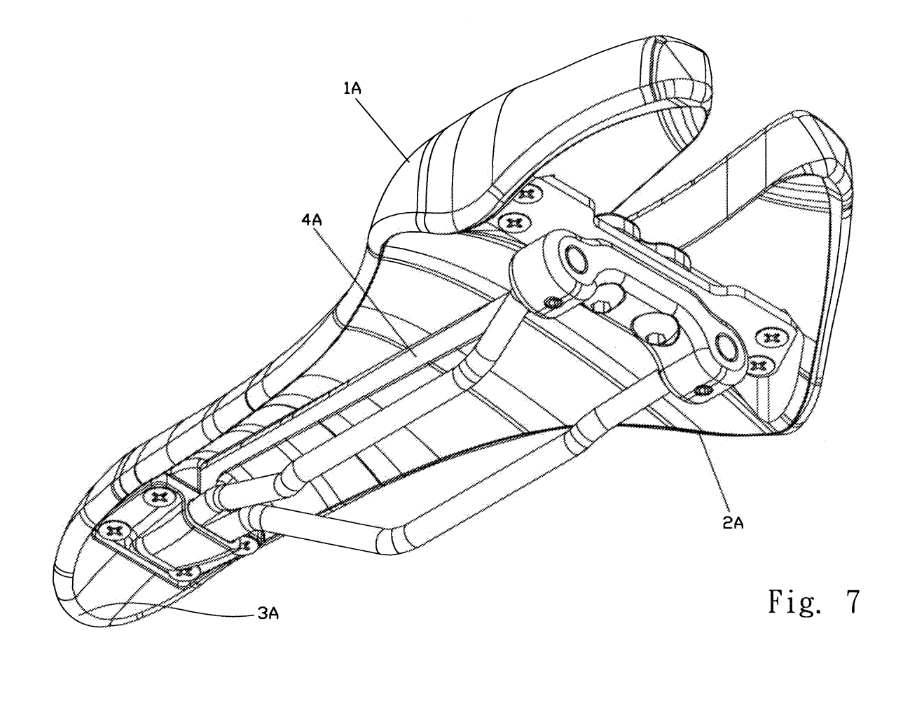

FIG. 7 shows another embodiment of the bicycle seat of the present invention, wherein the first and second parts 1A, 2A are connected at respective front ends thereof so as to from a closed area 3A and a gap 4A is defined longitudinally from the closed area 3A to the rear ends of the first and second parts 1A, 2A.

While we have shown and described the embodiment in accordance with the present invention, it should be clear to those skilled in the art that further embodiments may be made without departing from the scope of the present invention.

What is claimed is:

1. A bicycle seat comprising:
a first part having a narrow front end and a wide rear end;
a second part having a narrow front end and a wide rear end, the first and second parts being located side by side;
a spring member having two ends fixed to the two respective rear ends of the first and second parts respectively;
a first fixing member fixed to the spring member, and
a second fixing member connected across the two respective front ends of the first and second parts respectively.

2. The bicycle seat as claimed in claim 1, wherein the first and second parts are two individual parts.

3. The bicycle seat as claimed in claim 1, wherein the spring member includes at least one first threaded hole defined in a mediate portion thereof.

4. The bicycle seat as claimed in claim 3, wherein the first fixing member includes a second threaded hole which is located corresponding to the at least one first threaded hole, two passages are defined in two ends of the first fixing member, two third threaded holes are respectively defined through a wall of the two ends of the first fixing member and communicate with the two passages respectively.

5. The bicycle seat as claimed in claim 4, wherein a first bolt is connected to the second threaded hole of the first fixing member.

6. The bicycle seat as claimed in claim 4, wherein a second bolt is connected to the third threaded hole of the first fixing member.

7. The bicycle seat as claimed in claim 1, wherein the spring member is a spring board and includes two slots defined therein.

8. The bicycle seat as claimed in claim 1, wherein the second fixing member has a reception recess.

9. The bicycle seat as claimed in claim 8, wherein a frame includes a closed end, a first distal end and a second distal end, the closed end is inserted into the reception recess of the second fixing member.

10. The bicycle seat as claimed in claim 8, wherein the first and second parts are connected at respective front ends thereof so as to from a closed area and a gap is defined longitudinally from the closed area to the rear ends of the first and second parts.

11. The bicycle seat as claimed in claim 1, wherein the first fixing member fixed to an underside of the spring member
